(19) United States
(12) Patent Application Publication
(10) Pub. No.: US 2007/0016252 A1
(43) Pub. Date: Jan. 18, 2007

(54) Primary dental eruption teether

(76) Inventors: Amanda L. Doherty, Fiskdale, MA (US); Michele L. Everett-Servant, W. Brookfield, MA (US); Olga L. Restrepo, Sturbridge, MA (US)

Correspondence Address: Paul J. Cook, 115 Pine Street, Manchester, MA, 01944, US

(21) Appl. No.: 11/182,186

(22) Filed: Jul. 15, 2005

(51) Int. Cl. A61J 17/00

(52) U.S. Cl. 606/235

(57) ABSTRACT

A teether is provided for a baby which includes a physiologically acceptable deformable polymeric composition which conforms to the shape of the teeth and gums of a baby during use. The deformed teether retains its deformed shape after use by the baby.

### BACKGROUND OF THE INVENTION

This invention relates to a teether for a baby. More particularly, this invention relates to a teether for a baby which conforms to the shape of the teeth and gums of the baby during use.

Teethers are useful during painful teething in order to alleviate pain in the gums of the teething baby. The repetitive biting of the baby is relaxing to the baby. Conventional teethers are relatively resilient in that they revert to their original shape when the baby reduces chewing force on the teether. Since conventional teethers do not conform to the teeth and gum structure of the baby, oftentimes, the teether does not fully penetrate spaces between adjacent spaced apart teeth and this portion of the baby's gums does not experience the soothing experience of the remaining portion of the gums which contacts the teether under the force caused by the baby's chewing action.

Accordingly, it would be desirable to provide a baby teether capable of deforming to the shape of the teeth and gums of the teething baby and to retain its deformed shape to provide a soothing experience to the surfaces of the gums including the portion of the gums between adjacent spaced apart teeth. Such a teether would provide a more complete soothing experience for the teething baby.

### SUMMARY OF THE INVENTION

In accordance with this invention, a baby teether is provided which includes an arc shaped portion which is formed of a deformable polymeric composition that conforms to the shape of the gums and teeth of the baby under the chewing force of the baby and it retains that deformed shape. The arc shaped portion is anatomically correct for fitting into the baby's mouth. A handle to the housing is provided which extends outwardly between the baby's lips to prevent the teether from being swallowed during use. The teether is formed of physiologically acceptable materials so as to not cause harm to the baby. The arc shaped portion is shaped to fit on the mandibular (lower) jaw arch, the maxillary (upper) jaw arch or both the mandibular and maxillary jaw arches.

During use, the resilient arch will have the actual teeth indentations of the baby for the first teeth through the eruption of the first and second primary molars. Thus, the shape of the resilient arch will conform to the actual shape of the baby's teeth over the time of use.

In one embodiment, a kit having two teethers is provided, each having the structure described above but having two different sizes. A first teether has a size to accommodate the mandibular jaw arch. A second teether has a second size to accommodate the maxillary jaw arch. These teethers ca be used sequentially based upon which teeth of the baby are erupting.

### BRIEF DESCRIPTION OF THE DRAWINGS

FIG. 1 is a top view of a teether of this invention which accommodates both jaw arches.

FIG. 2 is a top view of a teether of this invention which accommodates mandibular jaw arch.

FIG. 3 is a top view of a teether of this invention which accommodates maxillary jaw arch.

### DETAILED DESCRIPTION OF SPECIFIC EMBODIMENTS

The teethers of this invention are formed of physiologically acceptable deformable polymeric composition which retains its deformed shape even when the chewing force of the baby is halted. The teethers of this invention can be formed of polysiloxane (silicone rubber), polyvinylacetate, polyalkylphthalates or the like. The deformable polymeric composition has a flexibility such that it can conform to the teeth and gums of the baby during chewing including the spaces between adjacent spaced-apart teeth which are emerging from the gums and that it retains the deformed shape even when the baby is not chewing the teether. The teether of this invention has an arc shaped section sized and shaped to accommodate one or both jaw arches of the baby.

A handle extends from the arc shaped section outwardly from the mouth of the baby. The handle and arc shaped section are formed integrally as one piece from the deformable polymeric composition. In a preferred embodiment, the handle is larger than the width of the baby's mouth to assure that the teether does not enter the baby's throat.

In normal babies, the first teeth eruption comprise the two front teeth on the lower jaw arch followed by the two teeth adjacent these front teeth on the lower jaw. The two front teeth on the upper jaw arch then erupt. Since the upper jaw arc has a different size and shape than the lower jaw arch, it is desirable to replace the teether sized for the lower jaw arch with a teether sized for the upper jaw arch. In this embodiment, a kit is provided with two teethers, one sized for the upper jaw arch and one sized for the lower jar arch. Alternatively, a teether can be provided which has a size to accommodate both the upper jaw arch and the lower jaw arch.

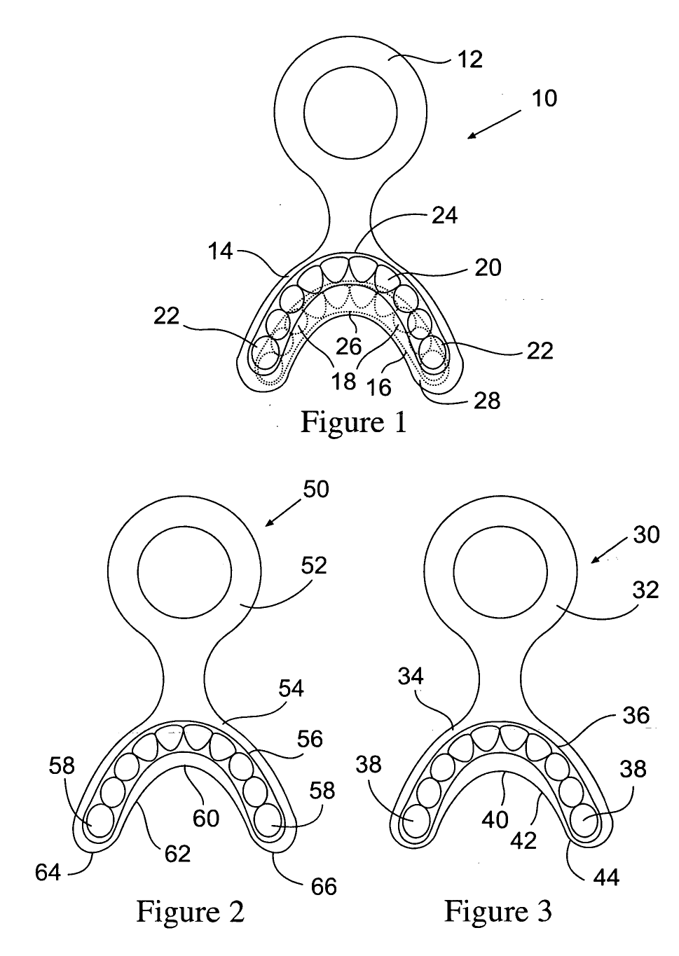

Referring to the FIG. 1, the teether 10 is formed of a physiologically acceptable deformable polymeric composition. The teether 10 includes a handle 12 and an arc shaped section 14. The arc shaped section 14 is sized to fit over the gums and teeth of both the mandibular jaw arch and the maxillary jaw arch. As shown in FIG. 1, after use, the arc shaped section 14 is deformed in the shape of both the mandibular arch 16 and teeth 18 as well as the maxillary arch 20 and teeth 22. A typical dimension between the most forward portion 24 of the maxillary arch 20 to the most forward point 26 of the inner edge 28 of the arc shaped section 14 is between about 1.25 and about 2.0 inches to conform to both the mandibular and maxillary jaw arches.

In use, the resilient polymeric composition is compressed by the jaw arches of the baby and, as a result, conforms to the shape of the baby's emerging teeth and gums, including the space between adjacent spaced apart teeth. As a result, substantially all of the baby's exposed gums are soothed by the compression force on the gums by the resilient polymeric composition exerted by the baby's chewing motion.

Referring to the FIG. 2, the teether 30 is formed of a physiologically acceptable deformable polymeric composition. The teether 30 includes a handle 32 and an arc shaped section 34. The arc shaped section 34 is sized to fit over the gums and teeth of the mandibular jaw arch. As shown in FIG. 2, after use, the arch shaped section 34 is deformed in the shape of the mandibular arch 36 and teeth 38. A typical dimension between the most forward point 40 of the inner edge 42 to each of the least forward points 44 or 46 is between about 1.25 and about 1.50 inches to conform to the mandibular jaw arch.

Referring to FIG. 3, the teether 50 is formed of a physiologically acceptable deformable polymeric composition. The teether 50 includes a handle 52 and an arch shaped section 54. The arc shaped section 54 is sized to fit over the gums and teeth of the maxillary jaw arch. As shown in FIG. 3, after use, the arch shaped section 54 is deformed in the shape of the maxillary arch 56 and teeth 58. A typical dimension between the most forward point 60 of the inner edge 62 to each of the least forward points 64 or 66 is between about 1.25 and about 2.0 inches to conform to the maxillary jaw arches.

1. A teether for a baby which comprises:
an arc shaped portion physiologically acceptable deformable polymeric composition having a size and shape to contact the entire upper and lower jaw arches of a baby,
said deformable polymeric composition having a deformability such that it conforms to the shape of the teeth and gums of the baby during use and retains the shape of at least one jaw arch of the baby after use,
and a handle formed integrally with said arc shaped portion and formed of a physiologically acceptable polymer composition.

2. A teether for a baby which comprises:
an arc shaped portion physiologically acceptable deformable polymeric composition having a size and shape to contact the entire maxillary jaw arch of a baby,
said deformable polymeric composition having a deformability such that it conforms to the shape of the teeth and gums of the baby during use and retains the shape of the maxillary jaw arch of the baby after use,
and a handle formed integrally with said arc shaped portion and formed of a physiologically acceptable polymer composition.

3. A teether for a baby which comprises:
an arc shaped portion physiologically acceptable deformable polymeric composition having a size and shape to contact the entire mandibular jaw arch of a baby,
said deformable polymeric composition having a deformability such that it conforms to the shape of the teeth and gums of the baby during use and retains the shape of the mandibular jaw arch of the baby after use,
and a handle formed integrally with said arc shaped portion and formed of a physiologically acceptable polymer composition.

4. The teether of claim 1 wherein the deformable polymeric composition is a polysiloxane composition.

5. The teether of claim 2 wherein the deformable polymeric composition is a polysiloxane composition.

6. The teether of claim 3 wherein the deformable polymeric composition is a polysiloxane composition.
